(19) United States
(12) Patent Application Publication
(10) Pub. No.: US 2013/0332378 A1
(43) Pub. Date: Dec. 12, 2013

(54) Methods and Systems for Integrated Social Media, Strategy, and Organizational Hierarchy

(71) Applicant: OrgSpan, Inc., Durham, NC (US)

(72) Inventors: Donald Brown, Indianapolis, IN (US); Eric Lanz, Cary, NC (US)

(21) Appl. No.: 13/911,597

(22) Filed: Jun. 6, 2013

Related U.S. Application Data
(60) Provisional application No. 61/656,322, filed on Jun. 6, 2012.

(51) Int. Cl. G06Q 50/00; G06Q 10/10

(52) U.S. Cl. CPC G06Q 50/01; G06Q 10/105
USPC 705/319

(57) ABSTRACT

Methods and systems for integrated social media, strategy, and organizational hierarchy are described. A method for integrated social media, strategy, and organizational hierarchy includes the steps of receiving information associated with organization members, the information including a name and an email address of each organization member. The information is arranged into an organization hierarchy, a format for presenting the organization hierarchy is determined, and the organization hierarchy is presented in a graphical user interface according to the determined format.

### CROSS-REFERENCE TO RELATED APPLICATIONS

This application claims priority from U.S. provisional application Ser. No. 61/656,322, filed 6 Jun. 2012.

### FIELD

This invention relates generally to enterprise social media applications, and in particular to methods and systems for integrated social media, strategy, and organizational hierarchy.

### BACKGROUND

Modern businesses and organizations can include hundreds or thousands of employees spread across many locations. Although technology such as email and instant messaging may facilitate communication between individual employees, determining the appropriate individual or team to communicate with across an organizational hierarchy can be cumbersome and time consuming.

Users may attempt to determine the appropriate individuals by using organizational directories or organizational charts. Typical organization directories may provide contact information in a tabular format showing each employee's first and last name, telephone number, and department. Such directories may be useful for finding a person's email address or phone number, but provide little more usefulness than a conventional telephone book. Traditional organizational charts may be too static or unwieldy to prove of any usefulness for facilitating communication across the organizational hierarchy, because direct and indirect relationships between employees at various hierarchical levels inside the organization may be hidden or obfuscated.

Thus there is a need for methods and systems to arrange and present organization information.

### SUMMARY

Methods and systems are described for integrated social media, strategy, and organizational hierarchy. In one embodiment, a method for integrated social media, strategy, and organizational hierarchy comprises receiving information associated with at least one component of an organization. Next, the method comprises determining a format for presenting at least a portion of the information. Then, the method comprises presenting the portion of the information in a graphical user interface according to the determined format.

In another embodiment, executable instructions are stored on a non-transitory computer-readable storage medium, the executable instructions that, when executed by a processor cause the processor to perform operations comprising receiving information associated with at least one component of an organization. Next, the executable instructions cause the processor to determine a format for presenting at least a portion of the information. Then, the executable instructions cause the processor to present the portion of the information in a graphical user interface according to the determined format.

Further embodiments, features, and advantages of the invention, as well as the structure and operation of the various embodiments of the invention are described in detail below with reference to the accompanying drawings.

### BRIEF DESCRIPTION OF THE DRAWINGS

The accompanying drawings, which are incorporated herein and form a part of the specification, illustrate embodiments of the present invention and, together with the description, serve to explain the principles of the invention and to enable a person skilled in the pertinent art to make and use the invention.

FIG. 1 is a flow chart illustrating a method for integrated social media and organizational hierarchy.

FIG. 2 is a block diagram illustrating a system for integrated social media and organizational hierarchy.

FIGS. 3-7 are screen shots illustrating a card view format of integrated social media, strategy, and organizational hierarchy.

FIGS. 8-12 are screen shots illustrating a star view format of integrated social media, strategy, and organizational hierarchy.

FIG. 13 is a screen shot illustrating a directory view format of integrated social media, strategy, and organizational hierarchy.

FIG. 14 is a screen shot illustrating a search view of integrated social media, strategy, and organizational hierarchy.

FIGS. 15-16 are screen shots illustrating a cloud view format of integrated social media, strategy, and organizational hierarchy.

FIG. 17 is a screen shot illustrating a browser view of integrated social media, strategy, and organizational hierarchy.

FIG. 18 is a screen shot illustrating a favorites view of integrated social media, strategy, and organizational hierarchy.

### DETAILED DESCRIPTION

Methods and systems are described for integrating social media, strategy, and organizational hierarchy. In one embodiment, an integrated services server receives information about individuals belonging to an organization from an Active Directory database. The information includes the individuals' name, title, department, picture, organization email address, organization phone number, office location, and relevant skills.

After the organization information is received, the integrated services server determines a format for arranging and presenting the information in a graphical user interface displayed on a mobile or desktop application, such as an iOS app, an Android application, a Windows 8 mobile app, or a web browser application.

The system may generate a contact card view for displaying the individuals in an easy to browse manner according to the organization hierarchy. In the embodiment, each individual is represented on a contact card presented in a graphical user interface.

### Example Method

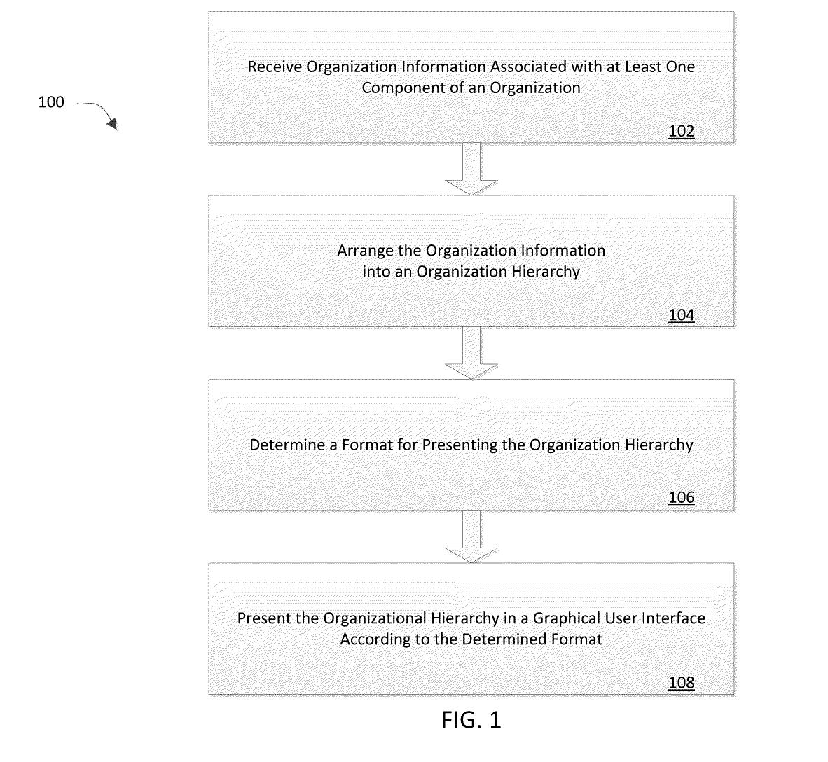

FIG. 1 is a flow chart illustrating a method 100 for integrated social media and organizational hierarchy. In the first step 102, organization information is received. The organization may comprise a corporation, charitable organization, partnership, team, or some other group of one or more individuals. The organization information may be associated with at least one organization component. An organization component may comprise an organization member or an organization resource, such as a document, computer, printer, office, meeting room, or building. In an embodiment, organizational components include members of the organization, such as the chief executive officer, an application developer, or a marketing associate. Information received, or collected, about the members may include their names, titles, departments, email addresses, telephone numbers, and office locations.

Information may be received from a directory service, such as Active Directory, Samba, Fedora Directory Server, OpenDS, or Apache Directory Server. In one embodiment, a large organization utilizes multiple Active Directory databases for tracking a plurality of organization components including security principles (e.g. users or user accounts) and resources (e.g. printers). A server, such as an integrated services server, may request, collect, and/or receive organization information stored by a directory service.

Organization information associated with an organization component may comprise social, strategic, and/or hierarchical information. As one example, an integrated services server may collect and/or receive basic directory information about some or all members of an organization, such as their names, titles, email addresses, and telephone numbers. Hierarchical information may include department memberships, team memberships, roles, subordinates, superordinates (e.g. managers, bosses, etc.), direct reports, and other relationships. Strategic and/or social information may include pictures (e.g. headshots or personnel pictures), hiring dates, salaries, production rating, and/or efficiency ratings. One of the advantages of the invention is the ability to collect, arrange, and present such disparate information in an easy accessible format.

In the second step 104, the organization information is arranged into an organization hierarchy. In one embodiment, an integrated services server analyzes the social media, strategic, and hierarchical data received from a directory service to generate an organization hierarchy. The organizational hierarchy may reflect various relationships, “dotted lines”, and roles within an organization. For example, the organizational hierarchy may include dotted line relationships, supervisory relationships, personal assistant contact preferences, and team roles.

In the third step 106, a format for presenting at least a portion of the information is determined. The format may be determined in relation to the device or platform presenting the information. For example, one or more formats may be preferable on certain devices, such as mobile phones or tablets, whereas other formats may be preferable on workstations and/or personal computers. Examples of presentation formats include a card view format, a creative view format, a tree view format, or a cloud view format.

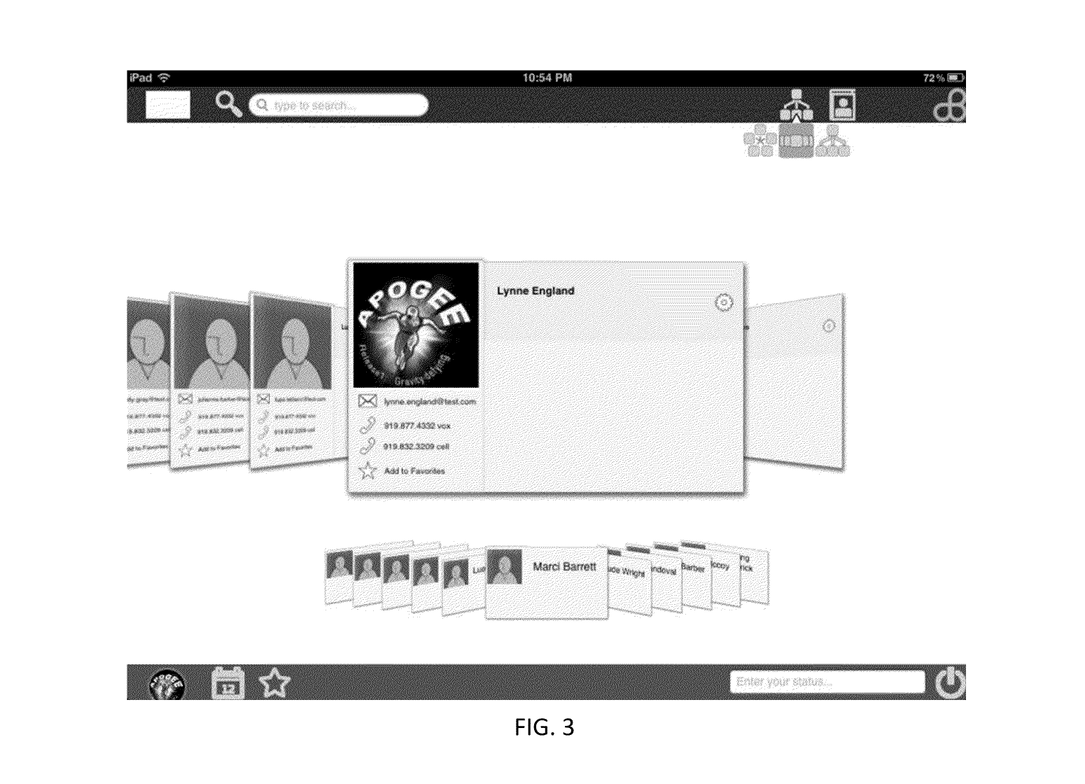

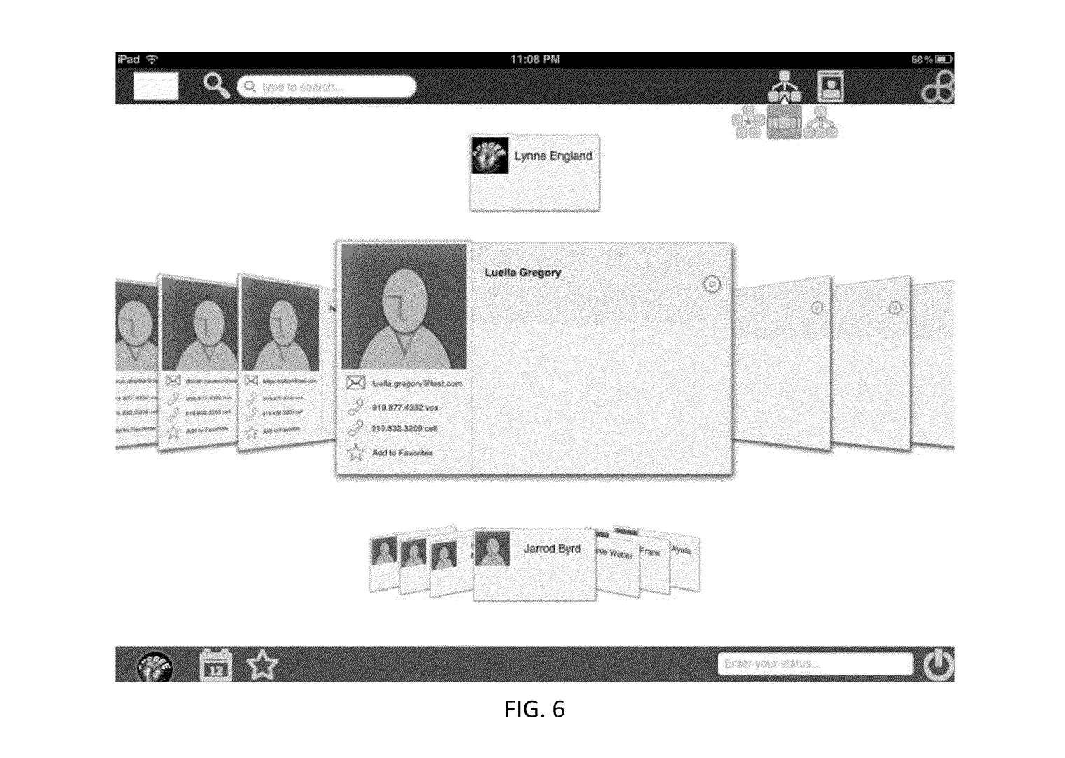

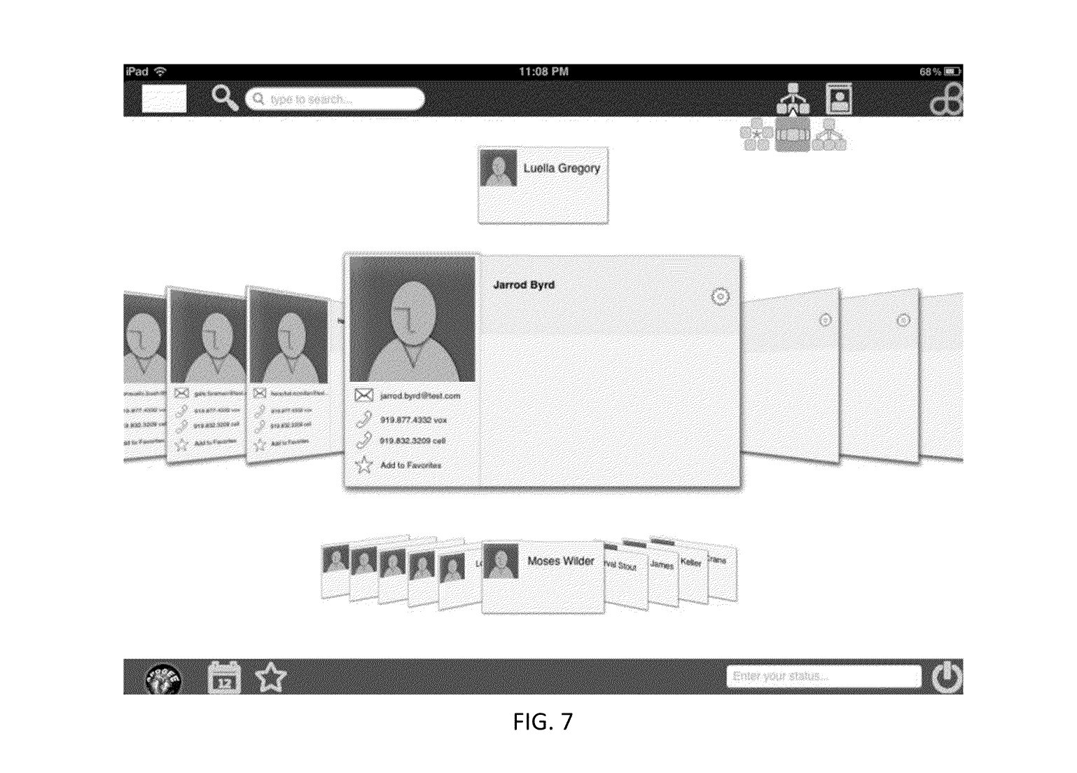

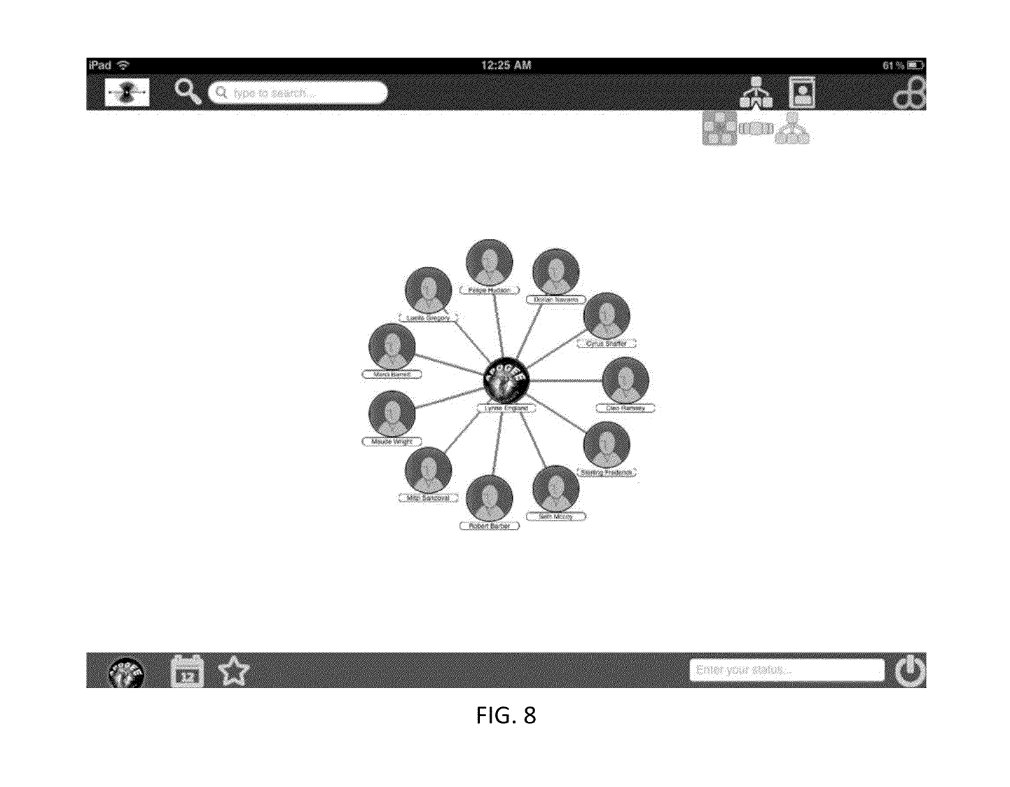

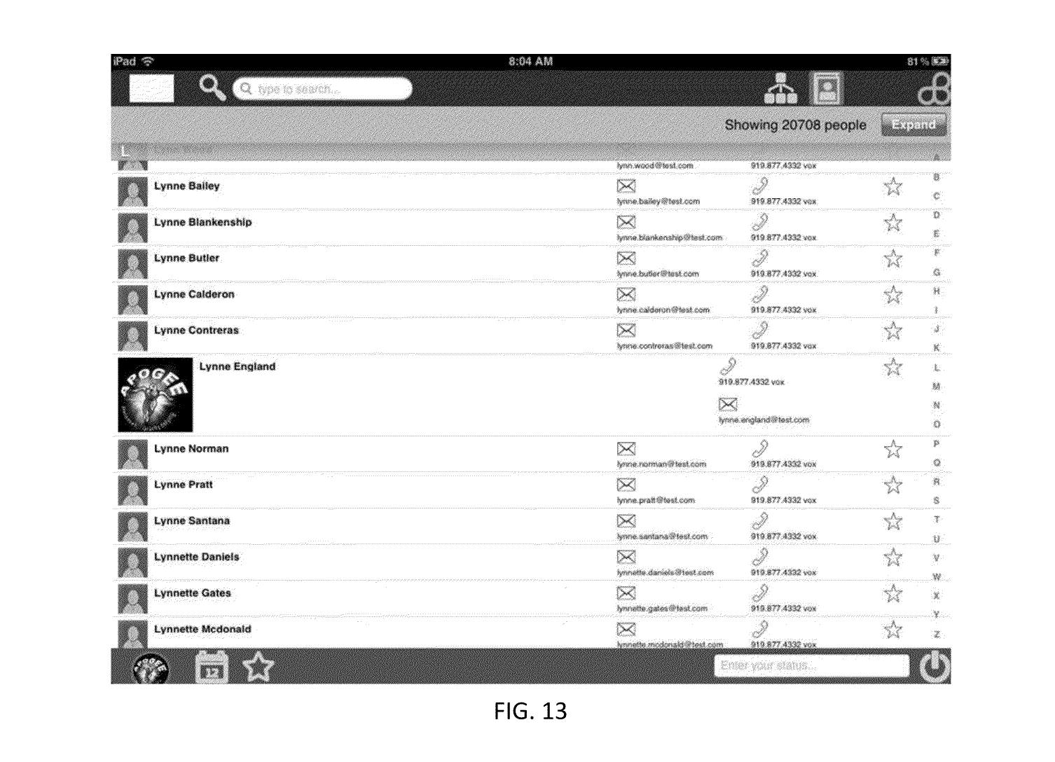

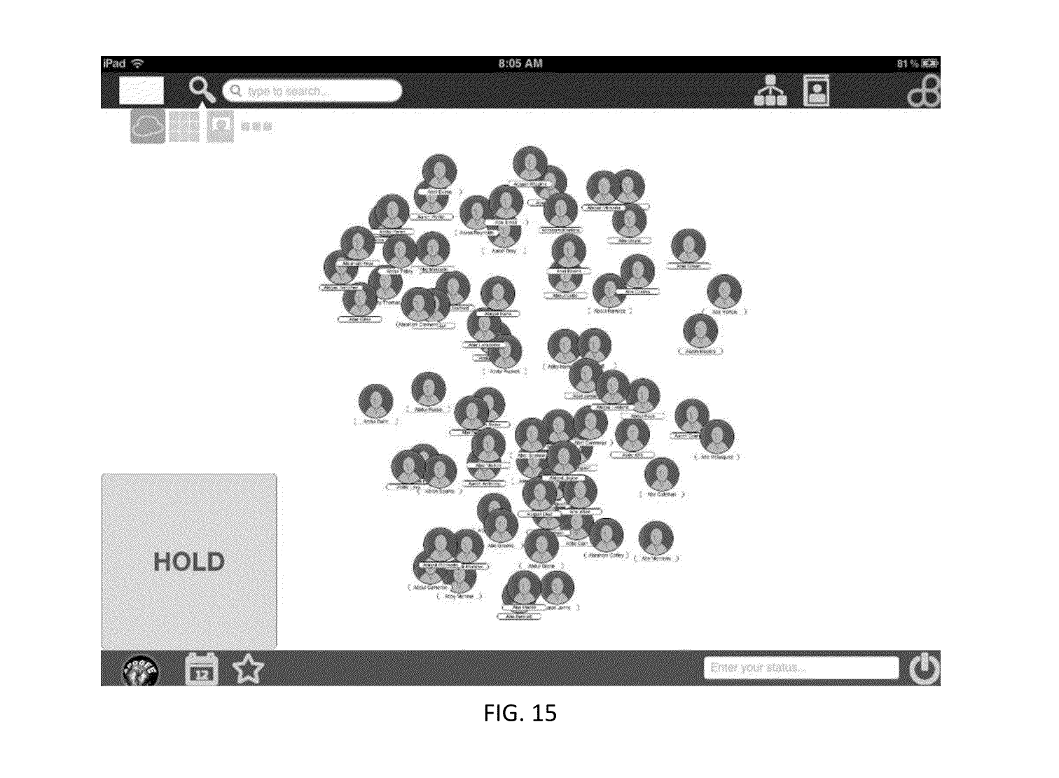

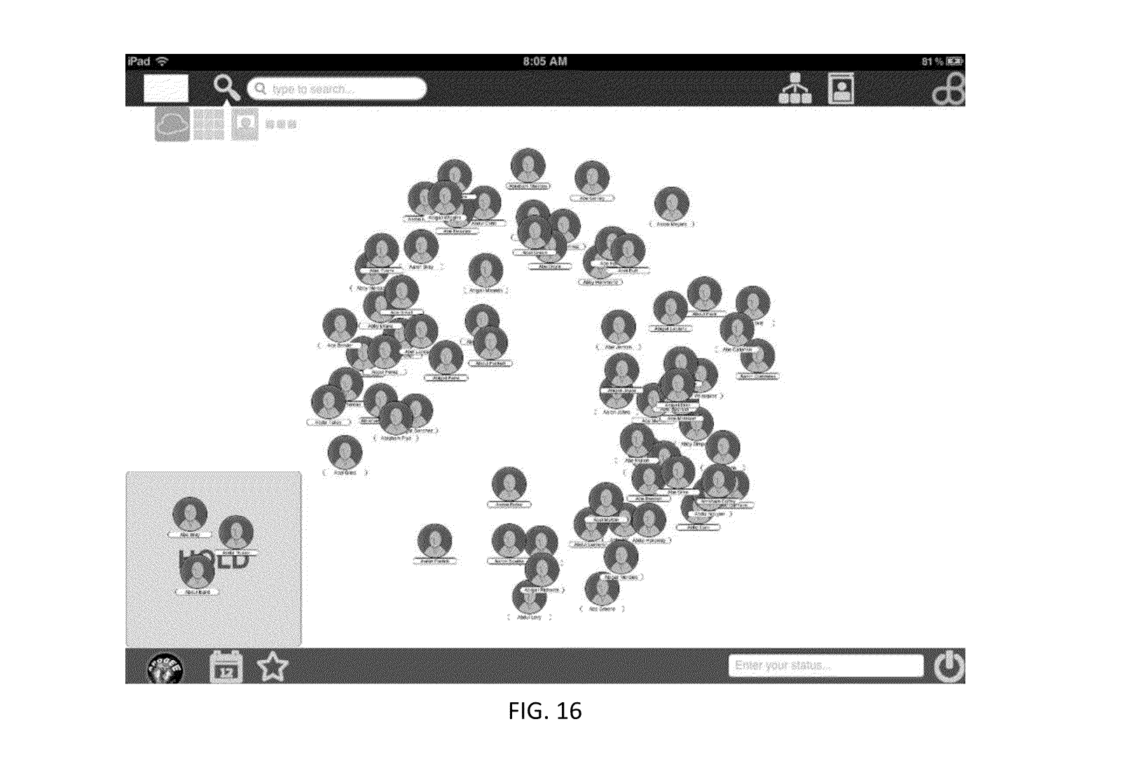

In the fourth step 108, the organization information is presented in a graphical user interface according to the determined format. In one embodiment, the organization information is presented in a card view format as illustrated in FIGS. 3-7. In another embodiment, the organization information is presented in a creative view format as illustrated in FIGS. 8-12. Other formats may include a directory view format, as illustrated in FIG. 13, and a cloud view format, as illustrated in FIGS. 15-16. Other formats may also be determined.

In another embodiment, a method for integrated social media, strategy, and organization hierarchy may comprise a computer program on a non-transitory computer readable medium, for execution by a computer, the computer program comprising: a code segment for receiving organization information associated with at least one component of an organization; a code segment for arranging the organization information into an organization hierarchy; a code segment for determining a format for presenting the organization information in the determined format; and a code segment for presenting the organization hierarchy in the determined format.

### Example System

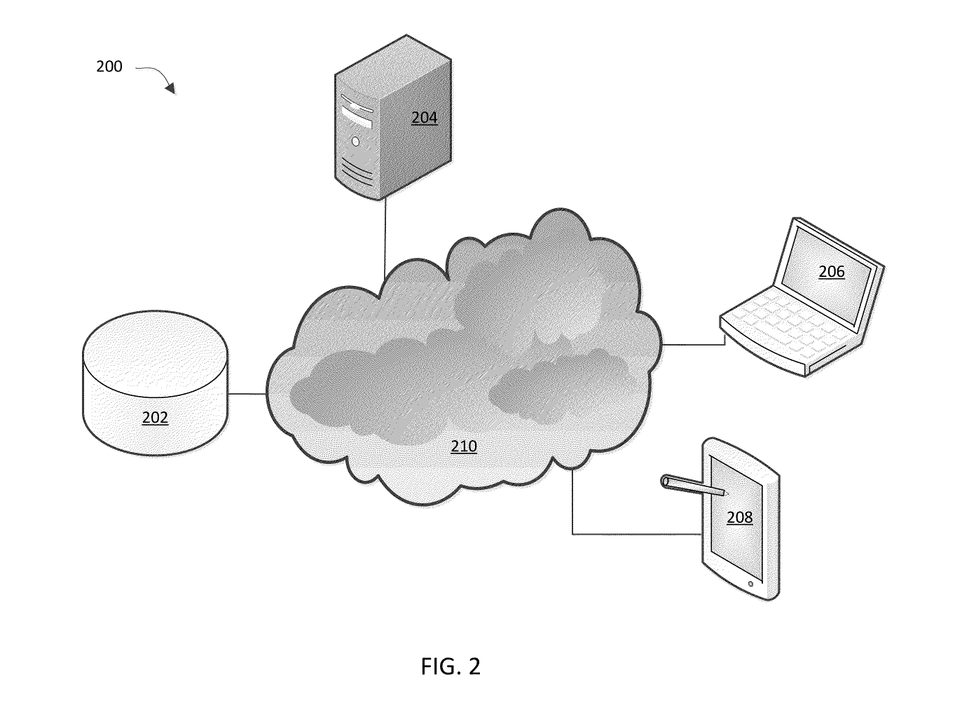

FIG. 2 is a block diagram illustrating a system 200 for integrated social media, strategy, and organizational hierarchy. As shown in FIG. 2, system 200 includes a database 202, an integrated services server 204, a personal computer 206, and a mobile device 208. As shown in FIG. 2, database 202, integrated services server 204, personal computer 206, and mobile device 208 are in communication over a network 210, such as the internet or a corporate intranet.

System 200 includes database 202, which may comprise one or more directory databases, such as a group of Active Directory databases. In other embodiments, other types of directory databases or organization information storage systems may be used.

System 200 also includes an integrated services server 204. The integrated services server may communicate with the database 202 and receive information, such as organization information, from the database 202 over network 210.

After receiving organization information from database 202, the integrated services server may arrange the organization information into an organizational hierarchy and determine a format for presenting some or all of the organization information.

The organization information may be presented on various computing devices, such as personal computer 206 and/or mobile device 208. Personal computer 206 may comprise a workstation, laptop, tower computer, or some other type of computing device. Mobile device 208 may comprise a smart phone, a tablet, an electronic-reader, or some other type of mobile or portable device.

The integrated services server 204 may use one or more factors to determine the presentation format, such as the device that the organization information is being displayed on. For example, if the organization information is being presented on mobile device 208, integrated services server 204 may choose a format optimized for the display size (e.g. less than 5″) and/or specific capabilities of the device (e.g. GPS locationing, gyroscopic input).

### Example Screen Shots

FIGS. 3-18 are screen shots of multiple views illustrating an application for integrated social media, strategy, and organizational hierarchy. Although the screenshots depicted in FIGS. 3-18 specifically reflect screenshots of an iOS tablet application for use on an Apple iPad™, in other embodiments such applications may operate on other computing platforms, such as iOS iPhones, Android phones, Android tablets, Windows mobile phones, Windows tablets, and/or web clients running on personal computers, such as desktops, laptops, and workstations.

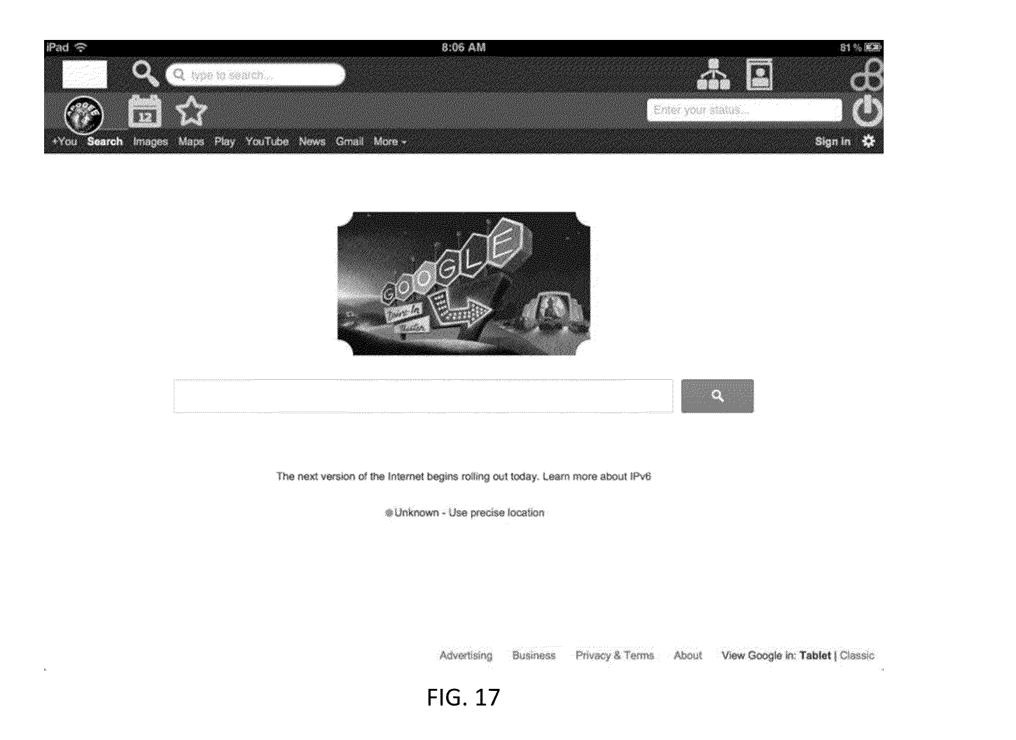

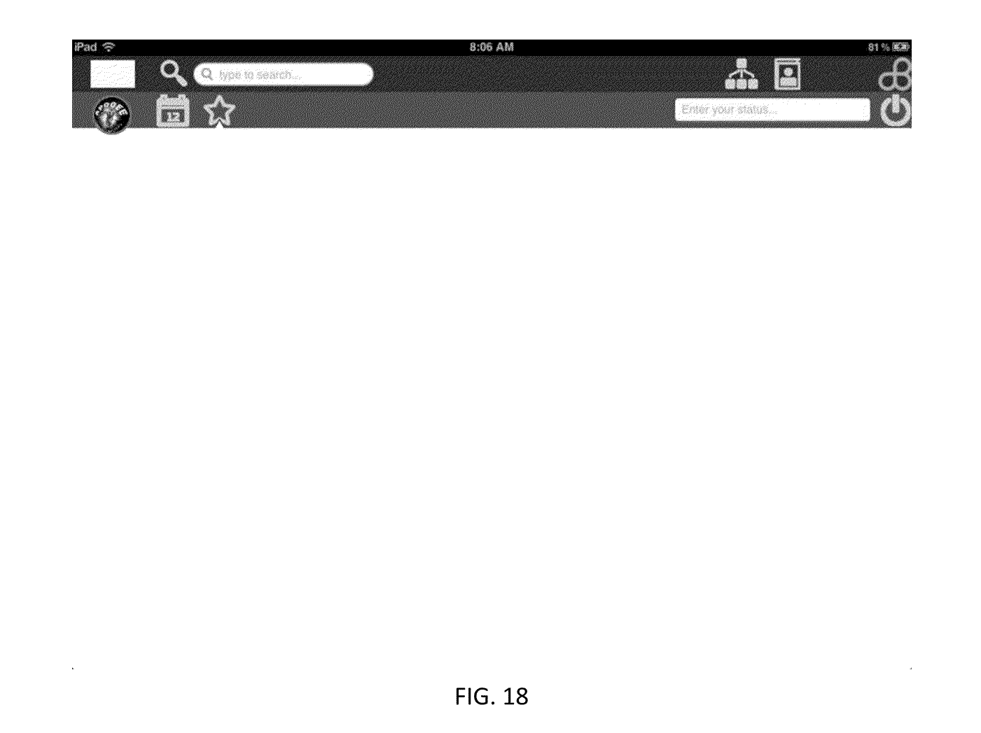

An organization hierarchy application may present aspects of the organization hierarchy in one or more perspectives. In the embodiments illustrated in FIGS. 3-18, FIGS. 3-16 may depict an organization perspective of the organization hierarchy, while FIGS. 17-18 may depict a personal perspective of the organization hierarchy. A user may navigate between different perspectives by interacting with one or more perspective affordances. For example, a user on an iPad device may touch or swipe a perspective navigation bar to see that perspective.

Each perspective may include one or more views. Users may navigate between views within each perspective by selecting or activating particular icons on the control bar, such as by typing a search query into the search box, selecting the tree view icon, selecting the favorites star view icon, or entering a status into the status bar.

Turning to particular views of the personal perspective, FIGS. 3-7 illustrate embodiments of a card view format for presenting organization information. As shown in FIGS. 3-7, information associated with individuals in an organization is presented according to one embodiment of a card view format. In the card view format, a representation of a contact card may be associated with each individual in the organization and displayed. Each card may show the name, picture, email address, telephone number, and cellular number of the associated individual.

One advantage of the invention is the ability to arrange and selectively present organization information based on a variety of criteria. Different perspectives and formats can be designed to automatically match the strategic needs and individual preferences of various users. The information shown for each individual may be determined by a system administrator. As one alternative, the information shown for each individual may be customized by an individual user, or according to a rule set associated with a classification of a user. For example, individuals classified as executives within an organization may be able to view certain information about individuals, such as their salary, or efficiency rate. Such information may not be displayed to individuals classified as associates or contractors.

In one embodiment, each individual in an organization is associated with a permission level. Information displayed by the system may be determined based in part on the permission level of the active user. An executive, such as the organization's President or Chief Executive Officer, may have an executive permission level. An hourly employee, such as a contractor, may have a more limited permission level.

In some embodiments, users may edit, annotate, save, “favorite”, “like”, or otherwise manipulate the presented information. For example, when viewing their own card, a user may be able to update their telephone number, office location, or status. Users may be able to add a card to their favorites, which may be stored for quick access at a later time. Users may also be able to add their own notes or comments to a card. For example, a user may add a reminder to email a team leader with a status report at the end of the week. Such a note may be synchronized with other software, such that a calendar reminder is automatically added for the user, and/or a task list is automatically updated.

In FIG. 3, an active card is prominently displayed in center of the graphical user interface. Such prominent display of the active card may include magnified font size to draw attention to information associated with the corresponding individual. In other views and/or in other formats, one or more active cards may be displayed simultaneously.

The active card in FIG. 3 comprises picture, name, email address, telephone voice number, and cell phone number information. Other information may also be displayed on each individual's card. In another embodiment not illustrated in FIG. 3, additional information shown on each card includes the individual's title, department, location, and/or a floor plan showing the individual's office.

Organization information associated with a plurality of individuals of an organization may be collected and displayed according to an organizational hierarchy. The card view format may display one or more hierarchical levels of an organization. When a plurality of individuals belongs to the same hierarchical level, each corresponding card may be displayed adjacent to the active card. When one or more individuals belong to a subordinate hierarchical level, their associated cards may be displayed in a level below the level of the active card.

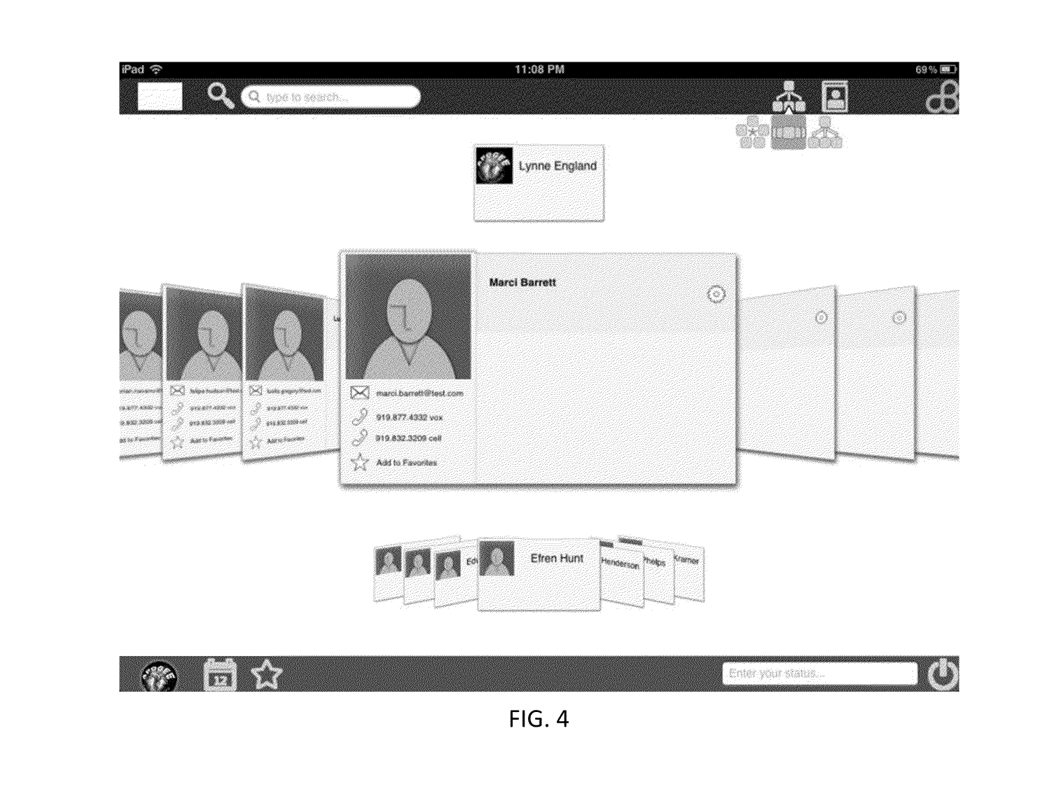

FIG. 3 illustrates two hierarchical levels of the organization in a single view. FIG. 3 shows a top level view of an organization, with a plurality of cards prominently displayed on a first level. A second level representing a subordinate hierarchical level is also shown in FIG. 3. In contrast to FIG. 3, FIG. 4 illustrates three hierarchical levels of the organization.

The card or cards shown at each hierarchical level of the card view format may be arranged according to the organization hierarchy and/or reporting relationships. For example, the card shown at the top level of FIG. 4, above the active card, may correspond to the supervisor or direct report of the person corresponding to the active card. Similarly, the cards shown on the bottom level, or subordinate level of FIG. 4, below the active card, may correspond to individuals that report to the person associated with the active card. The number of hierarchical levels accommodated by the card view format may be limited only by available system resources and/or design considerations, such as the speed for loading, storing, accessing, and displaying the organizational data.

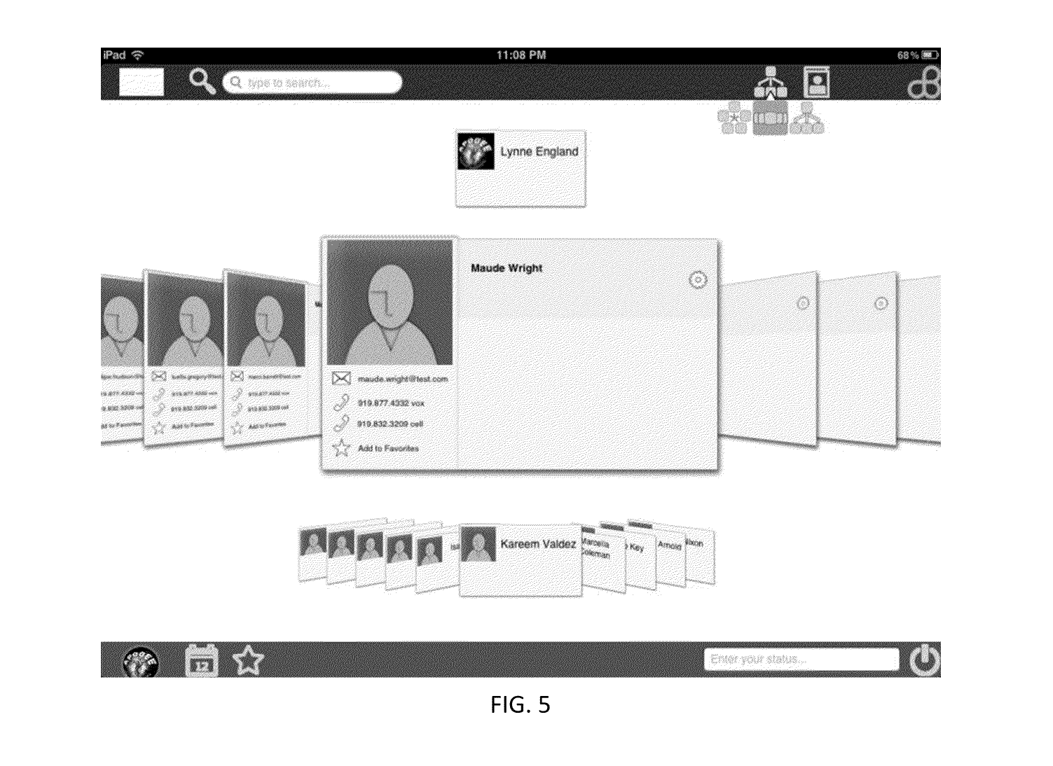

Another advantage of the invention is the generation of contextual information to help users understand and digest the organization information they are viewing. Contextual information may be ascertained based on the format and display of the organization information. For example, in FIG. 4, seven contact cards are shown in the subordinate level below the active card. In FIG. 5, ten contact cards are shown in the subordinate level below the active card. Accordingly, information such as the relative size of various teams or departments can be quickly ascertained by navigating through each level.

A user may navigate through each hierarchical level using scroll input commands. For example, a user may navigate from left to right or right to left by horizontal scrolling, horizontal swiping, and/or left or right arrows. A user may navigate about different hierarchical levels by scrolling up or down, vertical swiping, up and down arrows, and/or page up and page down buttons.

As a user navigates through different levels of the organizational hierarchy in the card view format, previous selections and/or actions may be remembered by the system. For example, a user may navigate through one level of an organizational hierarchy, and arrive at a particular individual. Later, after navigating above or below several levels of the hierarchy, when the user returns to the original hierarchical level, the active card returns to that same particular individual. Such behavior may provide continuity during use of the application as a user browses through organization information.

According to the embodiment illustrated in FIG. 3, the card view format may begin by showing individuals associated at the top level of the organization, or the highest hierarchical level. In other embodiments, an initial view may begin with the user's own card, or the last card that a user viewed.

The card view format may have two dimensional and/or three dimensional aspects. As a user scrolls from one level to the next, a graphical animation such as a group of cards expanding or exploding into the active level may be generated. Cards being moved away from the active level may collapse into a single card. Vertical scrolling through each hierarchical level of cards may simulate the rotation of a rolodex, with cards becoming larger as a level is scrolled to, and cards becoming smaller as a level is scrolled away from.

One alternative to the card view format is the creative view format. FIGS. 8-12 are screen shots illustrating the creative view format of integrated social media, strategy, and organizational hierarchy. In the creative view format, individuals may be represented by their pictures as presented in the shape of a round picture balloon. Relationships between individuals within the organization may be represented by lines connecting them with other individuals.

As shown in FIG. 8, eleven outer balloons, each balloon corresponding to an organization member, are each respectively connected with the same supervisor, shown as a balloon in the center of the group. Although FIG. 8 illustrates a hub-and-spoke display of members within a group, other manners of organizing the balloons are available. For example, individuals belonging to various teams within a group may be shown in a linear group at the top, sides, or bottom of the display, rather than merely surrounding the supervisor in a circle.

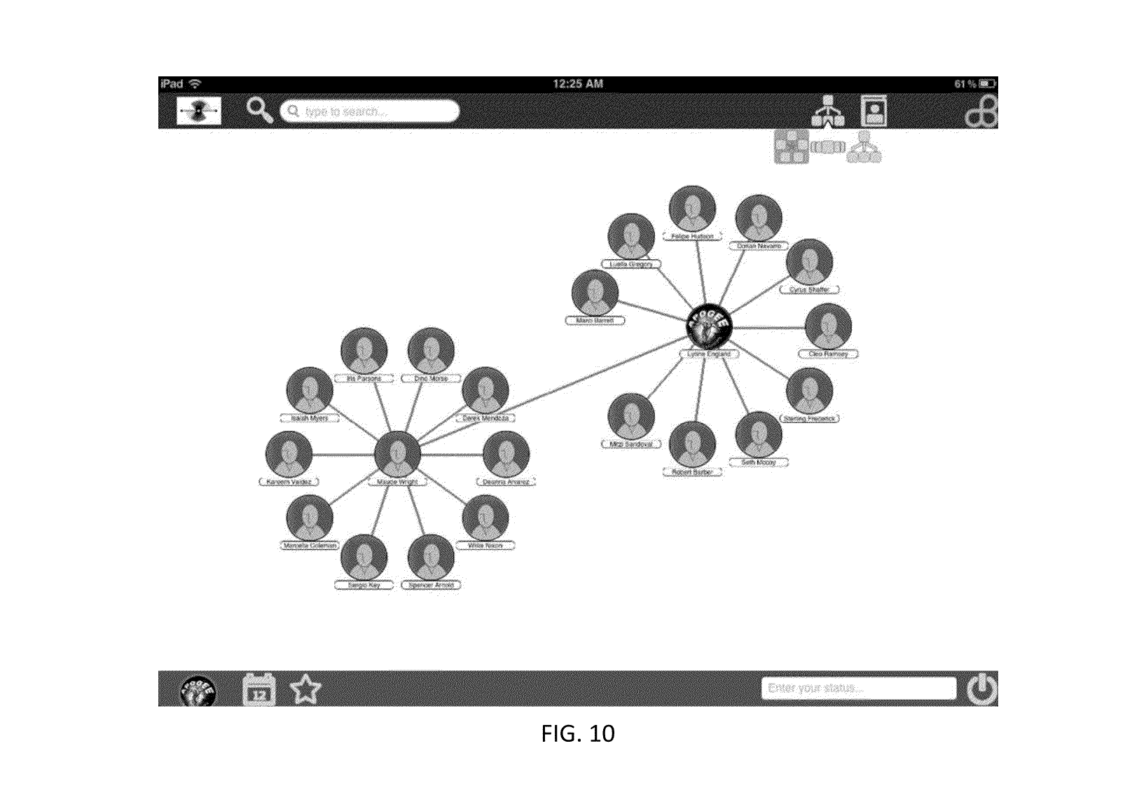

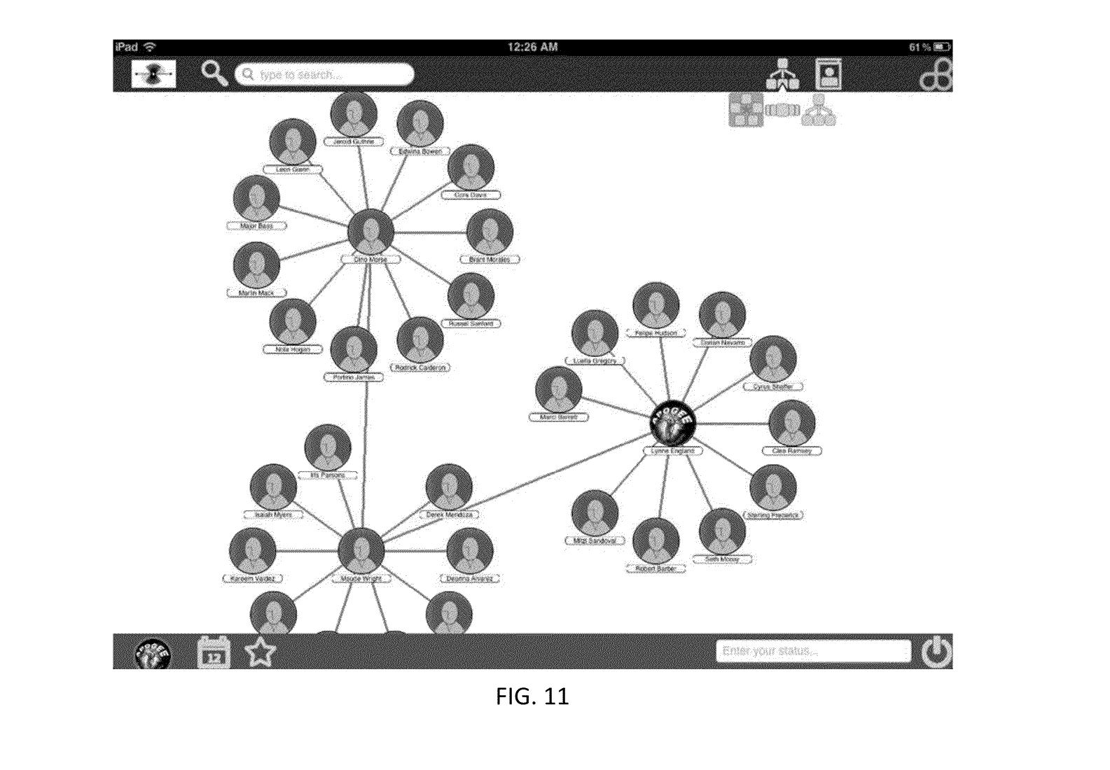

The creative view format may facilitate the display of multiple hierarchical levels in a variety of ways. For example, as shown in FIG. 10, the creative view format includes two different groups. In FIG. 11, the creative view format includes three different groups. An advantage of using the creative view format on a larger display is that the relationships between a large group of people, potentially across multiple hierarchical levels, can be quickly deduced.

Users may manipulate the creative view through various input gestures and commands. As one example, balloons may be dragged or pulled from their original or default position into a new position. For example, to generate the view shown in FIG. 11, a user may have dragged a first balloon from the original grouping shown in FIG. 8 to the left, thus generating the view shown in FIG. 10. Next, a user may drag a balloon shown in the newly displayed left circle upward, to create a third circle, thus generating the view shown in FIG. 11.

The creative view format may be generated as a two dimensional and/or three dimensional interface. In one embodiment, a third dimensional z axis may be used to indicate the relationship between different hierarchical levels. Each hierarchical level may appear above or below other hierarchical levels on a z axis, appearing closer or more distant to a user.

Other methods may be used to communicate information about the groups. In one embodiment, the hierarchical level of a balloon is reflected in its behavior, as represented by how a user interacts with the balloon. Members of the top level of the hierarchy may be anchored or tethered to a specific position within the creative view, whereas members of subordinate levels may be unanchored, or untethered.

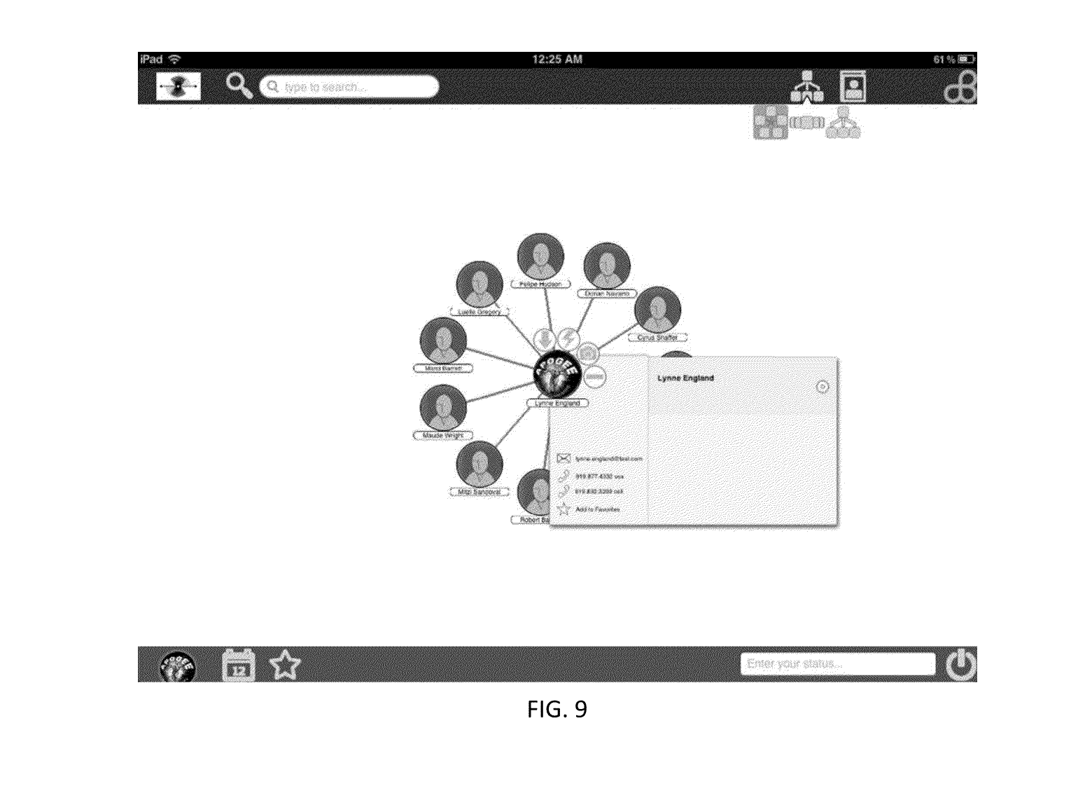

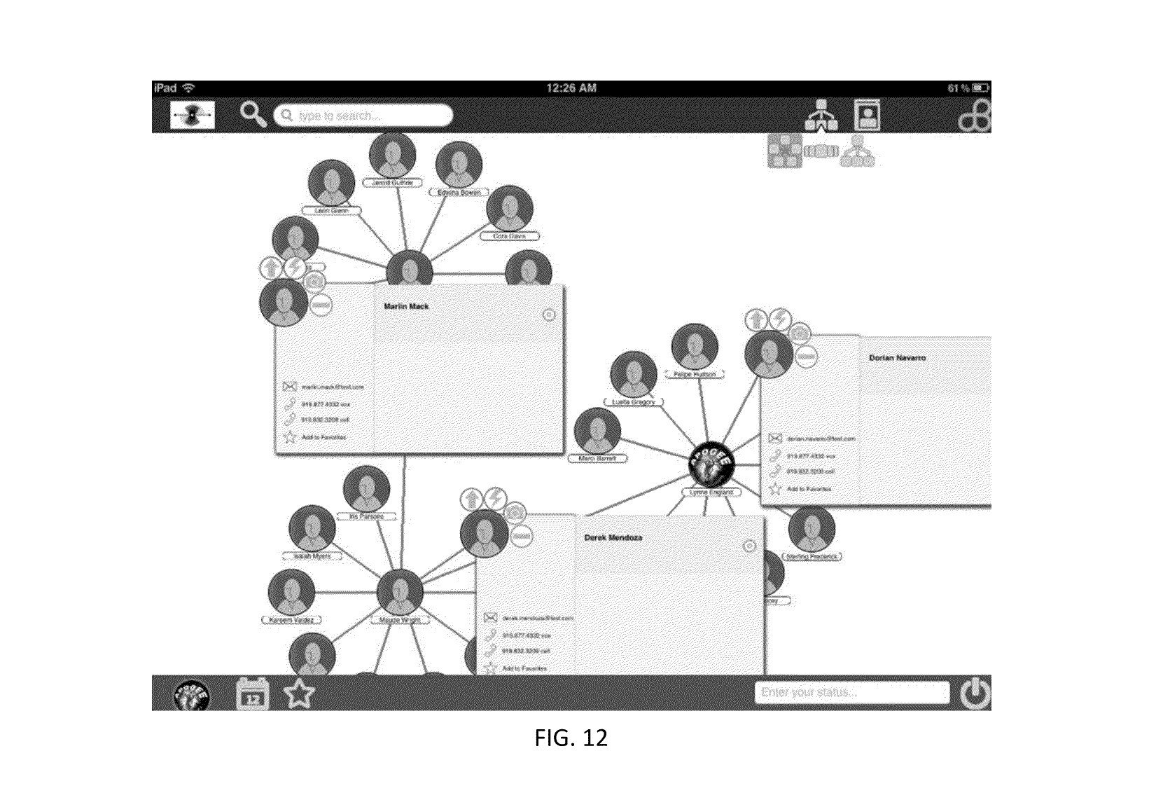

As shown in FIG. 9 and FIG. 12, the creative view format may display particular organization information through cards that correspond to individual people. For example, a contact card may be accessed by clicking, touching, or otherwise activating a specific balloon. As shown in FIG. 12, more than one contact card may be displayed in a single view.

FIG. 13 is a screen shot illustrating a directory view format of integrated social media, strategy, and organizational hierarchy. Organization information may be presented in a tabular format in the directory view. As shown in FIG. 13, each row in the directory view format is associated with an individual in the organization. Each row includes a picture, the name, email address, and phone number of the individual. In other embodiments, other information may be included or excluded in the directory view. Users may navigate the directory view through scrolling type inputs, such as touch-screen gestures, arrow buttons, and/or mouse gestures.

Although some user interactions and behaviors are specific to particular graphical formats, other behaviors may be shared across multiple view formats. For example, as illustrated in FIGS. 3-18, a sketchpad, or note box, may remain fixed in the upper left corner of the display. Users may save, or favorite, items shown in the various formats by dragging them to the sketchpad. As another example, a user may find a particular individual in the directory view, and then switch to the creative view. The creative view may automatically switch focus to center around the particular individual just found in the directory view.

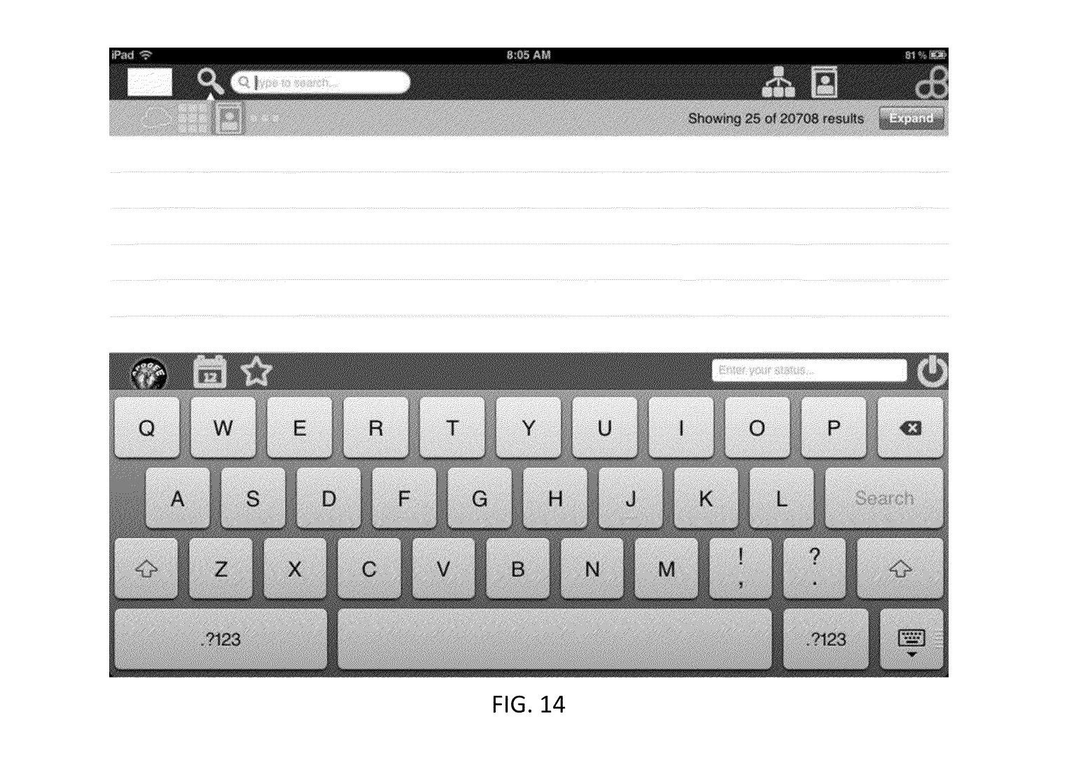

FIG. 14 is a screen shot illustrating a search view of integrated social media, strategy, and organizational hierarchy. By typing in one or more characters into the search box, the directory view may show results reflecting the search query. A user may search in one or more of the graphical formats generated by the system. As shown in FIGS. 3-18, the organizational bar remains constant across different views, reflecting an embodiment where a user may quickly and easily search any active view.

FIGS. 15-16 are screen shots illustrating a cloud view format of integrated social media, strategy, and organizational hierarchy. The cloud view format may represent members of the organization as freely floating balloons. In one embodiment, the relationship between individuals may be represented by the rough proximity of balloons to each other. For example, balloons proximate to each other in one section of the display may represent individuals belonging to related groups or teams, whereas balloons distant to that section represent individuals belong to unrelated groups or teams. One advantage to the cloud view format may be to reinforce a less hierarchical grouping of an organization, which may facilitate communication within and across groups or teams.

Users may manipulate balloons in the cloud view by dragging them across the display. As shown in FIG. 16, three balloons have been dragged to the hold area. These balloons may be saved, or remembered, for some action, such as creating a new team, or sending a targeted group email.

FIGS. 17-18 may comprise a personal perspective of the integrated social media, strategy, and organizational hierarchy application. The personal perspective may comprise a browser view, a calendar view, and a favorites view.

FIG. 17 is a screen shot illustrating a browser view of integrated social media, strategy, and organizational hierarchy. The browser view may comprise a web browser, for example, that specifically loads an organization's intranet homepage, or a particular web application. The browser may be a fully-functional web browser, such as a skinned version of Mozilla Firefox or Google Chrome. Users may drag items from a web page directly into their sketchpad shown in the upper left hand corner of the screen shot to save a copy of the item. Later, a user may view the sketchpad and drag an item such as a saved web page to a contact, initiating an email to that contact with the item included as an attachment.

FIG. 18 is a screen shot illustrating a favorites view of integrated social media, strategy, and organizational hierarchy. Items such as contact cards which have been “favorited”, or “starred” by a user may be stored here. Users may easily manipulate starred data to form new groups, create new meetings, reporting, or other purposes.

### Scope

Embodiments of a subset or all and portions or all of the above may be implemented by program instructions stored in a memory medium or carrier medium and executed by a processor. A memory medium may be a transitory medium or non-transitory medium. A memory medium may include any of various types of memory devices or storage devices. The term “memory medium” is intended to include an installation medium such as a Compact Disc Read Only Memory (CD-ROM) floppy disks, tape device, a computer system memory or random access memory such as Dynamic Random Access Memory DRAM Double Data Rate Random Access Memory DDR RAM Static Random Access Memory SRAM Extended Data Out Random Access Memory EDO RAM Rambus Random Access Memory RAM etc. or a non-volatile memory such as a magnetic media e.g. a hard drive or optical storage. The memory medium may comprise other types of memory as well or combinations thereof. In addition the memory medium may be located in a first computer in which the programs are executed or may be located in a second different computer that connects to the first computer over a network such as the Internet. In some instances the second computer may provide program instructions to the first computer for execution. The term memory medium may include two or more memory mediums that may reside in different locations e.g. in different computers that are connected over a network.

In some embodiments a computer system at a respective participant location may include a memory medium s on which one or more computer programs or software components according to one embodiment of the present invention may be stored For example the memory medium may store one or more programs that are executable to perform the methods described herein The memory medium may also store operating system software as well as other software for operation of the computer system.

Modifications and alternative embodiments of one or more aspects of the invention may be apparent to those skilled in the art in view of this description. Accordingly this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A method for integrating social media, strategy, and organizational hierarchy, the method comprising the steps of:
receiving organization information associated with a plurality of organization members, the organization information comprising a name and an email address of each one of the plurality of organization members;
arranging the organization information into an organization hierarchy;
determining a format for presenting the organization hierarchy; and
presenting aspects of at least some of the organization members in a graphical user interface according to the determined graphical format and the organization hierarchy.

2. A method for integrating social media, strategy, and organizational hierarchy, the method comprising the steps of:
receiving organization information associated with at least one component of an organization;
arranging the organization information into an organization hierarchy;
determining a format for presenting the organization hierarchy; and
presenting the organization hierarchy in the determined format.

3. The method of claim 2, wherein the at least one component is an organization member.

4. The method of claim 3, wherein the organization information comprises a name, a nickname, a title, a department, a telephone number, an email address, an office location, or a mailing address of the organization member.

5. The method of claim 2, wherein the component is a resource.

6. The method of claim 2, wherein the information is received from an Active Directory.

7. The method of claim 2, further comprising:
determining a permission level of a user;
determining a portion of the information to present based on the permission level.

8. The method of claim 3, further comprising:
receiving updated organization information; and
updating the organizational hierarchy based at least in part on the updated organization information.

9. The method of claim 2, further comprising:
receiving updated information associated with at least one component of an organization; and
updating the organization information associated with the at least one component.

10. A non-transitory computer-readable storage medium including executable instructions stored therein the executable instructions that, when executed by a processor cause the processor to perform operations comprising receiving information associated with at least one component of an organization. Next, the executable instructions cause the processor to determine a format for presenting at least a portion of the information. Then, the executable instructions cause the processor to present the portion of the information in a graphical user interface according to the determined format.

11. A computer program on a non-transitory computer readable medium, for execution by a computer, for integrated social media, strategy, and organizational hierarchy, the computer program comprising:
a code segment for receiving organization information associated with at least one component of an organization;
a code segment for arranging the organization information into an organization hierarchy;
a code segment for determining a format for presenting the organization information in the determined format; and
a code segment for presenting the organization hierarchy in the determined format.
